(19) United States
(12) Patent Application Publication
(10) Pub. No.: US 2024/0061011 A1
(43) Pub. Date: Feb. 22, 2024

(54) ACCELERATION SENSOR

(71) Applicant: ROHM CO., LTD., Kyoto (JP)

(72) Inventor: Yo YAMASHIRO, Kyoto (JP)

(21) Appl. No.: 18/498,415

(22) Filed: Oct. 31, 2023

Related U.S. Application Data
(63) Continuation of application No. PCT/JP2022/019490, filed on May 2, 2022.

(30) Foreign Application Priority Data
May 13, 2021 (JP) 2021-081427

(51) Int. Cl. G01P 15/125; G01P 15/08

(52) U.S. Cl. CPC G01P 15/125; G01P 15/0802

(57) ABSTRACT

A sensor element has a first and a second variable capacitor whose respective capacitance values vary in mutually opposite directions according to acceleration. A drive circuit modulates a first drive signal, to be fed to the sensor element to sense the acceleration, with a second drive signal having a predetermined modulation frequency and feeds the sensor element with a signal containing components corresponding to the first and second drive signals respectively. A sense signal generation circuit generates a sense signal according to the difference between the capacitance values of the first and second variable capacitors. An acceleration signal generation circuit generates an acceleration signal by subjecting the sense signal to low-pass filtering. A modulated component extraction circuit generates a modulated component extraction signal by extracting a signal component of the modulation frequency from the sense signal.

### CROSS-REFERENCE TO RELATED APPLICATIONS

This nonprovisional application is a continuation application of International Patent Application No. PCT/JP2022/019490 filed on May 2, 2022, which claims priority Japanese Patent Application No. 2021-081427 filed on May 13, 2021, the entire contents of which are hereby incorporated by reference.

### TECHNICAL FIELD

The present disclosure relates to acceleration sensors.

### BACKGROUND ART

As one type of acceleration sensor, capacitive acceleration sensors employing a MEMS (microelectromechanical system) are known.

### CITATION LIST

### Patent Literature

Patent Document 1: JP-A-2020-034397

### BRIEF DESCRIPTION OF DRAWINGS

FIG. 1 is a configuration diagram of an acceleration sensor according to a first embodiment of the present disclosure.

FIG. 2 is a configuration diagram of a sensor element according to the first embodiment of the present disclosure.

FIG. 3 is a diagram showing the relationship among the sensing band of the acceleration sensor and the frequencies of a first and a second drive signal according to the first embodiment of the present disclosure.

FIG. 4 is a diagram showing an outline of the waveforms of the first and second drive signals according to the first embodiment of the present disclosure.

FIG. 5 is a configuration diagram illustrating the signal processing on the output of the sensor element according to the first embodiment of the present disclosure.

FIG. 6 is a diagram showing an example of the waveform of a sense signal output from an A/D conversion circuit according to the first embodiment of the present disclosure.

FIG. 7 is a diagram showing an example of the waveform of the sense signal output from the A/D conversion circuit according to the first embodiment of the present disclosure.

FIG. 8 is a diagram illustrating the Coulomb forces produced by the second drive signal according to the first embodiment of the present disclosure.

FIG. 9 is a diagram showing the relationship among a plurality of frequencies and a plurality of bands according to the first embodiment of the present disclosure.

FIG. 10 is a diagram showing an example of the waveform of a modulated component extraction signal according to the first embodiment of the present disclosure.

FIG. 11 is a configuration diagram of a diagnosis circuit according to Practical Example EX1_A belonging to the first embodiment of the present disclosure.

FIG. 12 is a configuration diagram of a diagnosis circuit according to Practical Example EX1_B belonging to the first embodiment of the present disclosure.

FIG. 13 is a configuration diagram of an acceleration sensor according to a second embodiment of the present disclosure.

### DESCRIPTION OF EMBODIMENTS

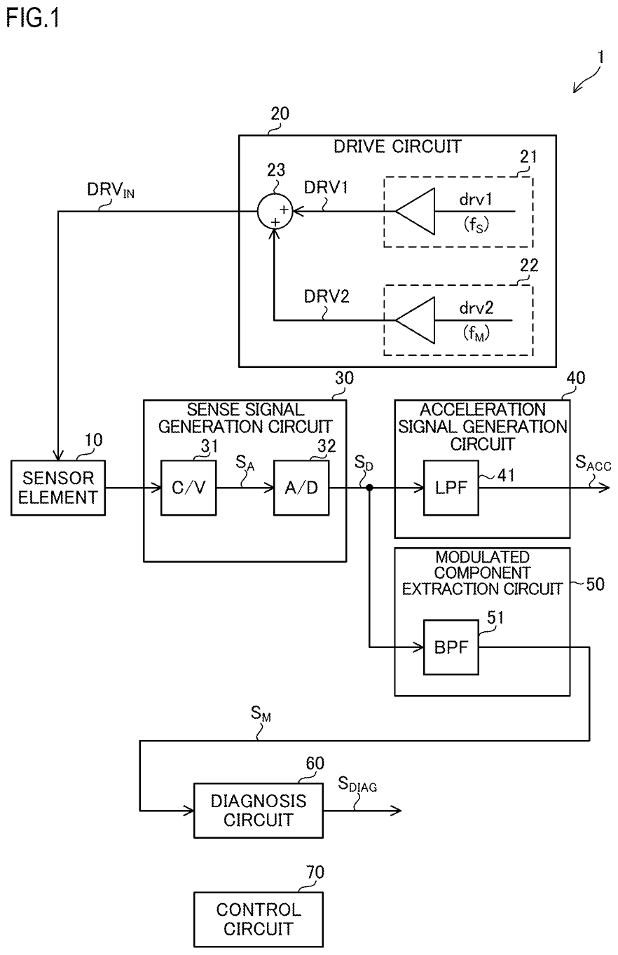

Examples of implementing the present disclosure will be specifically described below with reference to the accompanying drawings. Among the diagrams referred to in the course, the same parts are identified by the same reference signs, and in principle no overlapping description of the same parts will be repeated. In the present description, for the sake of simplicity, symbols and reference signs referring to information, signals, physical quantities, elements, parts, and the like are occasionally used with omission or abbreviation of the names of the information, signals, physical quantities, elements, parts, and the like corresponding to those symbols and reference signs. For example, the sense signal generation circuit described later and identified by the reference sign “30” (see FIG. 1) is sometimes referred to as “sense signal generation circuit 30” and other times abbreviated to “circuit 30,” both referring to the same entity.

First, some of the terms used to describe embodiments of the present disclosure will be defined. “Level” denotes the level of a potential, and for any signal or voltage of interest, “high level” has a higher potential than “low level.” For any signal or voltage of interest, its being at high level means, more precisely, its level being equal to high level, and its being at low level means, more precisely, its level being equal to low level. For any signal that takes as its signal level high level or low level, the period in which the signal is at high level is referred to as the high-level period and the period in which the signal is at low level is referred to as the low-level period. The same applies to any voltage that takes as its voltage level high level or low level. Wherever “connection” is discussed among a plurality of parts constituting a circuit, as among circuit elements, wirings, nodes, and the like, the term is to be understood to denote “electrical connection.”

### First Embodiment

A first embodiment of the present disclosure will be described. FIG. 1 is a configuration diagram of an acceleration sensor 1 according to the first embodiment. The acceleration sensor 1 includes a sensor element 10, a drive circuit 20, a sense signal generation circuit 30, an acceleration signal generation circuit 40, a modulated component extraction circuit 50, a diagnosis circuit 60, and a control circuit 70.

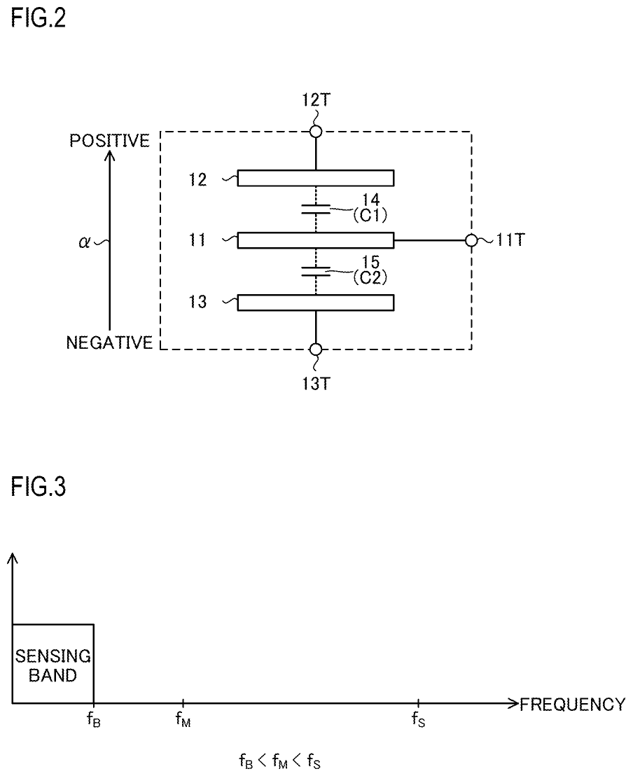

The sensor element 10 is a capacitive acceleration sensor employing a MEMS (microelectromechanical system). FIG. 2 shows the configuration of the sensor element 10. The sensor element 10 has a fixed electrode 11 and movable electrodes 12 and 13. The fixed electrode 11 and the movable electrodes 12 and 13 constitute a capacitor pair composed of variable capacitors 14 and 15. The variable capacitor 14 is formed between the fixed electrode 11 and the movable electrode 12, and the variable capacitor 15 is formed between the fixed electrode 11 and the movable electrode 13. The electric capacitance value of the variable capacitor 14 will be represented by the symbol “C1,” and the electric capacitance value of the variable capacitor 15 will be represented by the symbol “C2.” “Electric capacitance value” will often be referred to simply as “capacitance value.” The electrodes 11 to 13 are disposed in a row along an a-axis, which is a predetermined straight axis, with the fixed electrode 11 located between the movable electrodes 12 and 13. The sensor element 10 has a terminal 11T connected to the fixed electrode 11, a terminal 12T connected to the movable electrode 12, and a terminal 13T connected to the movable electrode 13. The potentials at the electrodes 11, 12, and 13 are equal to the potentials at the terminals 11T, 12T, and 13T respectively.

In the acceleration sensor 1, while the fixed electrode 11 remains at a fixed position, the movable electrodes 12 and 13 change their positions along the a-axis relative to the position of the fixed electrode 11 in accordance with acceleration. In this embodiment, acceleration means that which acts on the acceleration sensor 1 and the sensor element 10 along the a-axis. It is here assumed that, relative to the fixed electrode 11, the movable electrode 12 is located on the positive side along the a-axis and the movable electrode 13 is located on the negative side along the a-axis.

When the acceleration is zero, the capacitance values C1 and C2 are equal to a predetermined reference capacitance value common between them (though an error may be present). When positive acceleration acts on the sensor element 10, as compared with when the acceleration is zero, the distance between the electrodes 11 and 12 increases and the distance between the electrodes 11 and 13 decreases, with the result that the capacitance value C1 decreases from the reference capacitance value and the capacitance value C2 increases from the reference capacitance value. When negative acceleration acts on the sensor element 10, as compared with when the acceleration is zero, the distance between the electrodes 11 and 12 decreases and the distance between the electrodes 11 and 13 increases, with the result that the capacitance value C1 increases from the reference capacitance value and the capacitance value C2 decreases from the reference capacitance value. In this way, the capacitance values of the variable capacitors 14 and 15 in the sensor element 10 vary in mutually opposite directions in accordance with the acceleration that acts on the sensor element 10 along the a-axis.

The drive circuit 20 feeds the sensor element 10 with a drive signal DRV_{IN} for driving the sensor element 10. In the configuration shown in FIG. 1, the drive circuit 20 includes a first drive signal generation circuit 21, a second drive signal generation circuit 22, and an adder 23.

The first drive signal generation circuit 21 generates a drive signal drv1 and outputs a drive signal DRV1 based on the drive signal drv1. The drive signals drv1 and DRV1 are each a rectangular-wave signal with a predetermined frequency f_{S}. Feeding the drive signal drv1 to a driver (buffer circuit) results in producing the drive signal DRV1. The second drive signal generation circuit 22 generates a drive signal drv2 and outputs a drive signal DRV2 based on the drive signal drv2. The drive signals drv2 and DRV2 are each a rectangular-wave signal with a predetermined frequency f_{M}. Feeding the drive signal drv2 to a driver (buffer circuit) results in producing the drive signal DRV2. The drive signals DRV1 and DRV2 are fed to the adder 23. The adder 23 modulates the drive signal DRV1 with the drive signal DRV2, and generates and outputs the modulated drive signal DRV1 as the drive signal DRV_{IN}. That is, the drive signal DRV_{IN} corresponds to a signal that is a mixture of the drive signals DRV1 and DRV2, and contains components corresponding to the drive signals DRV1 and DRV2 respectively. The frequency f_{M} corresponds to the modulation frequency and will be referred to as the modulation frequency f_{M} in the following description.

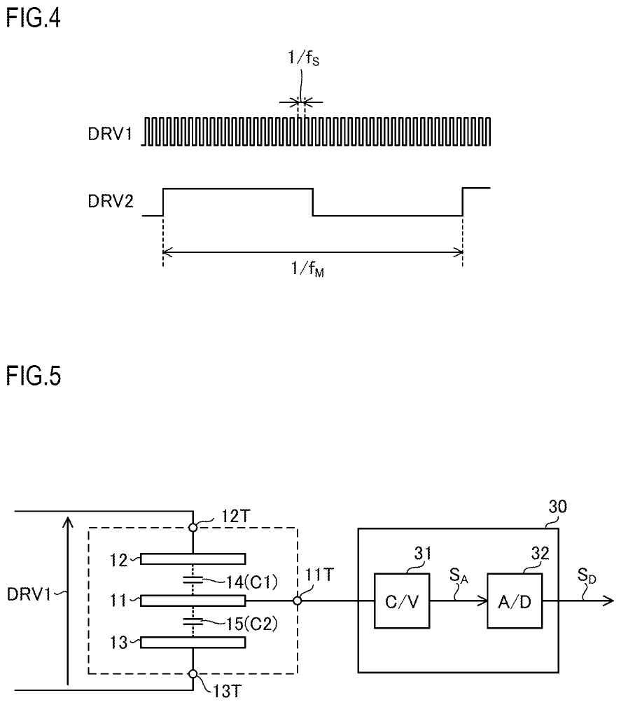

FIG. 3 shows the relationship among the sensing band and the frequencies f_{M} and f_{S} in the acceleration sensor 1. FIG. 4 shows an outline of the waveforms of the drive signals DRV1 and DRV2. The sensing band represents the frequency band of the acceleration that the acceleration sensor 1 is expected to sense, and is defined in the specifications of the acceleration sensor 1. The sensing band is a band equal to or lower than a predetermined frequency f_{B}. The acceleration sensor 1 is not expected to be able to sense acceleration at frequencies above the sensing band. The frequency f_{M} is higher than the frequency f_{B}, and the frequency f_{S} is still higher than the modulation frequency f_{M}.

Moreover, because of a mechanical limit of response, in the sensor element 10, the frequency of the variation of the distances between the electrodes 11 and 12 and between the electrodes 11 and 13 has an upper limit. The upper-limit frequency (the resonance frequency of the sensor element 10) is higher than the frequency f_{M} but lower than the frequency f_{S}. Accordingly, while the feeding of the drive signal DRV1 to the sensor element 10 does not cause variation in the capacitance values C1 and C2, the feeding of the drive signal DRV2 to the sensor element 10 cause variation in the capacitance values C1 and C2.

Of the drive signals DRV1 and DRV2, the drive signal DRV1 is the one that is to be fed to the sensor element 10 for the sensing of acceleration. Accordingly, for the convenience of description, for the time being the drive signal DRV2 is ignored (i.e., it is assumed that DRV_{IN}=DRV1) and a description will be given of an example of the operation for sensing acceleration with reference to FIG. 5. The sense signal generation circuit 30 includes, as blocks for generating a signal corresponding to acceleration, a C/V conversion circuit 31 and an A/D conversion circuit 32.

The drive signal DRV1 contained in the drive signal DRV_{IN} is applied between the terminals 12T and 13T. The terminal 11T is connected to the C/V conversion circuit 31. The drive signal DRV1 is a rectangular-wave signal that alternates between high and low levels. During the high-level period of the drive signal DRV1, the terminal 12T is fed with a voltage higher, relative to the terminal 13T, by a voltage based on the amplitude of the drive signal DRV1; during the low-level period of the drive signal DRV1, the terminal 13T is fed with a voltage higher, relative to the terminal 12T, by a voltage based on the amplitude of the drive signal DRV1.

The C/V conversion circuit 31 operates in synchronization with the drive signal DRV1, and generates and outputs a sense signal S_{A} corresponding to the difference (C1−C2) between the capacitance values C1 and C2 based on the voltage at the terminal 11T during the high-level period of the drive signal DRV1 and the voltage at the terminal 11T during the low-level period of the drive signal DRV1. The sense signal S_{A} is an analog voltage signal and has an analog value that is proportional to the difference (C1−C2) between the capacitance values C1 and C2. That is, the C/V conversion circuit 31 converts the difference (C1−C2) between the capacitance values C1 and C2 into an analog voltage signal. The conversion here can be achieved by any known method. For example, the C/V conversion circuit 31 can be configured with a switched capacitor circuit, a sample-and-hold circuit, and a differential amplifier circuit (of which none is illustrated).

The A/D conversion circuit 32 converts, by A/D conversion (analog-to-digital conversion), the analog sense signal S_{A} from the C/V conversion circuit 31 into a digital sense signal S_{D}. It is here assumed that the A/D conversion circuit 32 performs delta-sigma AD conversion and that the sampling frequency of the A/D conversion circuit 32 is the frequency f_{S}.

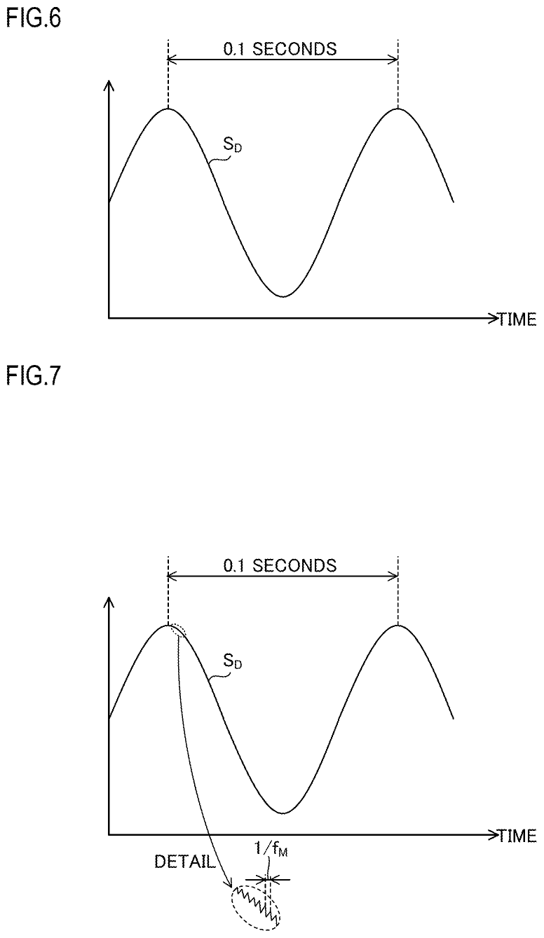

The sense signal S_{D} has a digital value that represents the analog value of the sense signal S_{A}. That is, the sense signal S_{D} has a digital value corresponding to the difference (C1-C2) between the capacitance values C1 and C2. More specifically, the sense signal S_{D} has a digital value that is proportional to the just-mentioned difference (C1−C2). Thus, the sense signal S_{D} has a waveform that reflects the amplitude and direction of acceleration. FIG. 6 shows an outline of the waveform of the sense signal S_{D} as observed when the acceleration sensor 1 is acted on by acceleration of which the magnitude varies in a sine-wave form at 10 Hz.

As described above, by operating the C/V conversion circuit 31 in synchronization with the drive signal DRV1, it is possible to obtain signals (S_{A}, S_{D}) corresponding to acceleration. The description thus far of the operation for sensing acceleration ignores the drive signal DRV2; in practice, the drive signal DRV1 is modulated with the drive signal DRV2. Accordingly, the sense signal S_{D} contains a signal component of the modulation frequency f_{M} and varies at the modulation frequency f_{M} (see FIG. 7).

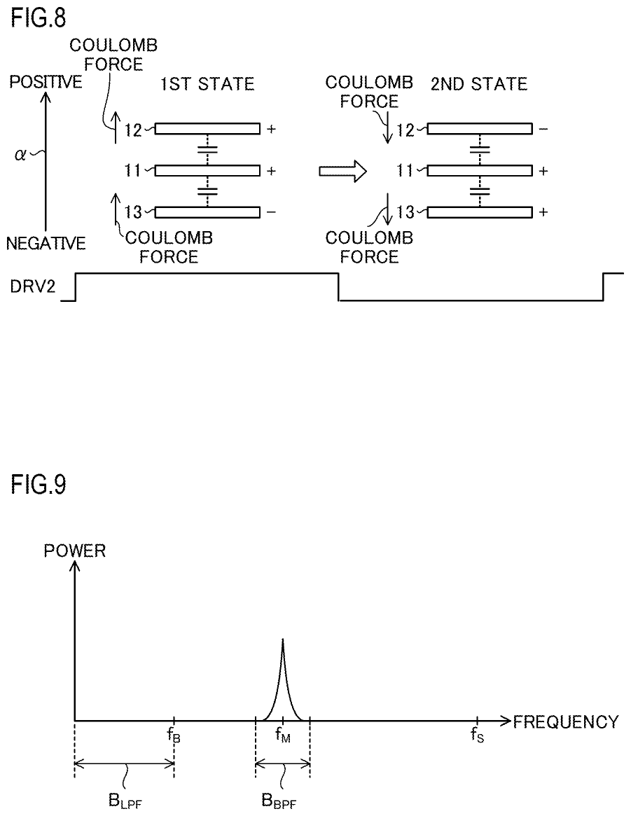

With reference to FIG. 8, the effect of the drive signal DRV2 will be described. The drive signal DRV2 is a rectangular-wave signal that alternates between high and low levels. Based on the drive signal DRV2 contained in the drive signal DRV_{IN}, the sensor element 10 changes its state alternately between a first state and a second state. In the high-level period of the drive signal DRV2, the sensor element 10 is in the first state. In the first state, the potentials at the fixed electrode 11 and the movable electrode 12 are, relative to the potential at the movable electrode 13, higher by a voltage corresponding to the amplitude of the drive signal DRV2. In the low-level period of the drive signal DRV2, the sensor element 10 is in the second state. In the second state, the potentials at the fixed electrode 11 and the movable electrode 13 are, relative to the potential at the movable electrode 12, higher by a voltage corresponding to the amplitude of the drive signal DRV2. Here, in practice, during the high-level period of the drive signal DRV2, relative to the first state, the potentials at the electrodes 11 to 13 vary based on the component corresponding to the drive signal DRV1; during the low-level period of the drive signal DRV2, relative to the second state, the potentials at the electrodes 11 to 13 vary based on the component corresponding to the drive signal DRV1.

In the high-level period of the drive signal DRV2, based on the component corresponding to the drive signal DRV2, Coulomb forces act on the movable electrodes 12 and 13 in the positive direction along the a-axis (a repulsive force between the electrodes 11 and 12 and an attractive force between the electrodes 11 and 13). In the low-level period of the drive signal DRV2, based on the component corresponding to the drive signal DRV2, Coulomb forces act on the movable electrodes 12 and 13 in the negative direction along the a-axis (an attractive force between the electrodes 11 and 12 and a repulsive force between the electrodes 11 and 13). It is thus possible to simulate a condition as if, with the drive signal DRV2, the acceleration sensor 1 is acted on by acceleration of the modulation frequency f_{M}, and thus the sense signals S_{A} and S_{D} come to contain a signal component based on the above-mentioned Coulomb forces (i.e., a signal component of the modulation frequency f_{M}).

Referring back to FIG. 1, the acceleration signal generation circuit 40 subjects the sense signal S_{D} to predetermined low-pass filtering and thereby generates and outputs an acceleration signal S_{ACC} corresponding to acceleration. The acceleration signal S_{ACC} is a signal that represents the amplitude and direction of acceleration. The acceleration signal generation circuit 40 includes an LPF (low-pass filter) 41, and the LPF 41 performs the low-pass filtering. Since the sense signal S_{D} is a digital signal, the LPF 41 is configured as a digital low-pass filter. The LPF 41 may be configured as a single-stage low-pass filter, or as a muti-stage low-pass filter.

The cut-off frequency of the low-pass filtering by the LPF 41 will be referred to by the symbol “f_{CO}.” The LPF 41 passes, of the signal components of the sense signal S_{D}, those with frequencies equal to or lower than the cut-off frequency f_{CO} while attenuating those with frequencies higher than the cut-off frequency f_{CO}. The so attenuated sense signal S_{D} is generated and output as the acceleration signal S_{ACC}.

In FIG. 9, the band B_{LPF} represents the band extracted by the LPF 41 (i.e., the band equal to or lower than the cut-off frequency f_{CO}). The cut-off frequency f_{CO} is set to the frequency f_{B} (see FIG. 3; e.g., 100 Hz) that is the upper limit of the sensing band, or to a frequency (e.g., 120 Hz) higher than the frequency f_{B} by a predetermined frequency. Thus, the acceleration signal S_{ACC} contains a signal component corresponding to acceleration within the sensing band with a sufficiently strong signal intensity, Incidentally, so long as the specifications of the acceleration sensor 1 are met, the cut-off frequency f_{CO} may be set to a frequency (e.g., 90 Hz) lower than the frequency f_{B} by a predetermined frequency. On the other hand, the modulation frequency f_{M} is higher than the cut-off frequency f_{CO}, and thus the signal component of the frequency f_{B} in the sense signal S_{D} is sufficiently attenuated by the low-pass filtering in the LPF 41. It is thus possible to extract an acceleration signal S_{ACC} that, with modulated components eliminated, only contains the component corresponding to actual acceleration.

The modulated component extraction circuit 50 subjects the sense signal S_{D} to predetermined band-pass filtering to extract the signal component of the modulation frequency f_{M} from the sense signal S_{D}, and generates and outputs the extracted signal as a modulated component extraction signal S_{M}. The modulated component extraction circuit 50 includes a BPF (band-pass filter) 51, and the BPF 51 performs the band-pass filtering. Since the sense signal S_{D} is a digital signal, the BPF 51 is configured as a digital band-pass filter.

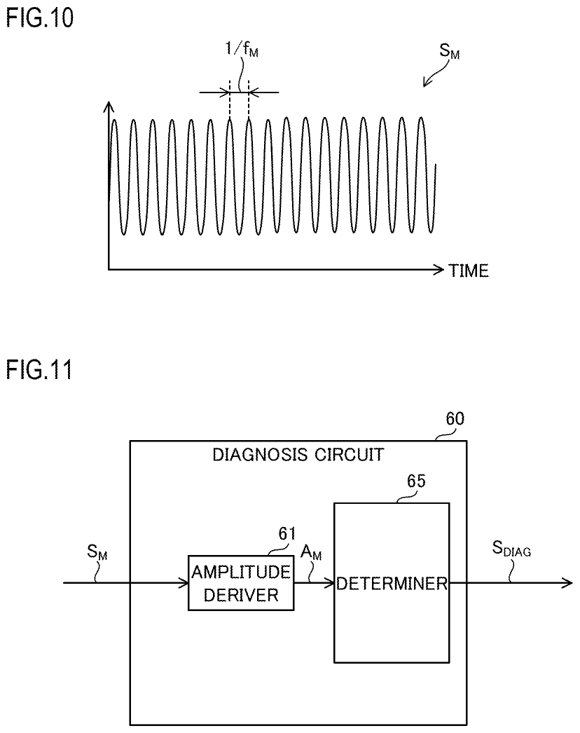

In the band-pass filtering, a predetermined pass band is defined. The modulation frequency f_{M} is a frequency within the pass band. In FIG. 9, the band B_{BPF} represents the band extracted by the BPF 51 (i.e., the pass and of the BPF 51). FIG. 9 also schematically shows the spectrum of the modulated component extraction signal S_{M}. The BPF 51 passes, out of the signal components of the sense signal S_{D}, those with frequencies within the pass band while attenuating those with frequencies outside the pass band, and thereby extracts the signal component of the modulation frequency f_{M} from the sense signal S_{D}. The signal components of frequencies within the pass band may be, while they are passed, emphasized (amplified). FIG. 10 schematically shows an example of the signal waveform of the modulated component extraction signal S_{M}.

The BPF 51 is designed such that, in the modulated component extraction signal S_{M}, the signal component of the modulation frequency f_{M} has a signal strength sufficiently higher than the signal components outside the pass band. So that, in the modulated component extraction signal S_{M}, the signal components of the frequency f_{B} or lower and the signal component of the frequency f_{S} have sufficiently low signal strengths, the lower-limit frequency of the pass band can be set to be sufficiently higher than the frequency f_{B} and than the cut-off frequency f_{CO} of the LPF 41 and the upper-limit frequency of the pass band can be set to be sufficiently lower than the frequency f_{S}.

Based on the modulated component extraction signal S_{M}, the diagnosis circuit 60 diagnoses the state of the sensor element 10 and generates and outputs a diagnosis signal S_{DIAG} indicating the result of the diagnosis. The diagnosis signal S_{DIAG} is a signal related to the state of the sensor element 10 (a signal that represents the state of the sensor element 10). More specifically, it is a signal indicating whether the sensor element 10 has a fault. That is, the diagnosis in the diagnosis circuit 60 determines whether the sensor element 10 has a fault. It is here assumed that the diagnosis signal S_{DIAG} is a binary signal that has the value of either “0” or “1.” A diagnosis signal S_{DIAG} with the value “1” serves as a signal indicating that the sensor element 10 has a fault. A signal indicating that the sensor element 10 has a fault can be understood as a signal that indicates the possibility of the sensor element 10 having a fault. A diagnosis signal S_{DIAG} with the value “0” serves as a signal indicating that the sensor element 10 is normal. A signal indicating that the sensor element 10 is normal can be understood as a signal that indicates that the sensor element 10 has no fault.

The control circuit 70, along with the drive circuit 20, the sense signal generation circuit 30, the acceleration signal generation circuit 40, the modulated component extraction circuit 50, and the diagnosis circuit 60, constitutes a signal processing circuit. The control circuit 70 has a function of comprehensively controlling the operation of the individual blocks in the signal processing circuit.

The control circuit 70 has a function of transmitting the acceleration signal S_{ACC} as it is, or a signal based on the acceleration signal S_{ACC}, to an external device (unillustrated) connected to the acceleration sensor 1. The acceleration signal S_{ACC} can be transmitted to the external device while it is updated at a predetermined cycle (e.g., a cycle equal to the reciprocal of 100 Hz). Here, the acceleration signal generation circuit 40 itself may, without depending on the control circuit 70, transmit the acceleration signal S_{ACC} to the external device. The control circuit 70 also has a function of transmitting the diagnosis signal S_{DIAG} as it is, or a signal based on the diagnosis signal S_{DIAG}, to the external device. Here, the diagnosis circuit 60 itself may, without depending on the control circuit 70, transmit the diagnosis signal S_{DIAG} to the external device. The control circuit 70 can have any further functions, of which a description will be given later.

The first embodiment includes Practical Examples EX1_A and EX1_B as described below. Now, by way of Practical Examples EX1_A and EX1_B, examples of the operation or configuration of the diagnosis circuit 60 will be described in detail.

### Practical Example EX1_A

Practical Example EX1_A will be described. FIG. 11 shows the internal configuration of the diagnosis circuit 60 of Practical Example EX1_A. The diagnosis circuit 60 of Practical Example EX1_A includes an amplitude deriver 61 and a determiner 65. The amplitude deriver 61 derives the amplitude A_{M} of the modulated component extraction signal S_{M}. Based on the derived amplitude A_{M}, the determiner 65 generates the diagnosis signal S_{DIAG}. The diagnosis signal S_{DIAG} generated is output from the diagnosis circuit 60.

The determiner 65 generates the diagnosis signal S_{DIAG} according to whether the amplitude A_{M} of the modulated component extraction signal S_{M} falls outside a predetermined normal amplitude range. If the amplitude A_{M} falls outside the predetermined normal amplitude range, the determiner 65 generates a diagnosis signal S_{DIAG} with the value of “1”; if the amplitude A_{M} falls within the predetermined normal amplitude range, the determiner 65 generates a diagnosis signal S_{DIAG} with the value of “0.” If the sensor element 10 is normal, the movable electrodes 12 and 13, fed with the drive signal DRV2, are supposed to vibrate mechanically at the modulation frequency f_{M} with an adequate amplitude, and in this case the amplitude A_{M} is expected to fall within the normal amplitude range.

The normal amplitude range can be a range from a predetermined lower-limit amplitude A_{TH_L} to a predetermined upper-limit amplitude A_{TH_H} (where 0<A_{TH_L}<A_{TH_H}). In this case, if the inequality A_{TH_L}≤A_{M}≤A_{TH_H} holds, the diagnosis signal S_{DIAG} is given the value of “0”; if the inequality A_{M}<A_{TH_L} or A_{TH_H}<A_{M} holds, the diagnosis signal S_{DIAG} is given the value of “1.”

The normal amplitude range can be a range that is defined by a lower-limit amplitude A_{TH_L} alone. In that case, if the inequality A_{TH_L}≤A_{M} holds, the amplitude A_{M} is judged to fall within the normal amplitude range and the diagnosis signal S_{DIAG} is given the value of “0”; if the inequality A_{M}<A_{TH_L} holds, the amplitude A_{M} is judged to fall outside the normal amplitude range and the diagnosis signal S_{DIAG} is given the value of “1.”

If a diagnosis signal S_{DIAG} with the value of “1” is output, the control circuit 70 can latch that value and transmit a predetermined indication signal to the external device (unillustrated) connected to the acceleration sensor 1 (the same applies to Practical Example EX1_B and any embodiments described later).

### Practical Example EX1_B

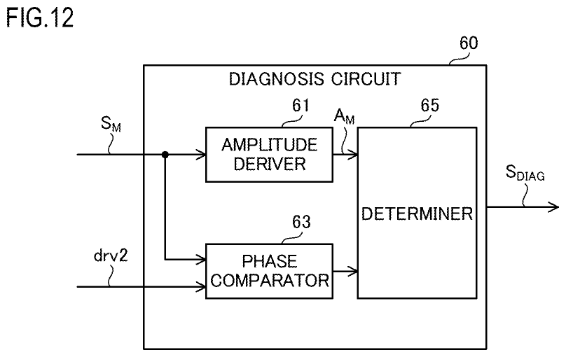

Practical Example EX1_B will be described. FIG. 12 shows the internal configuration of the diagnosis circuit 60 of Practical Example EX1_B. The diagnosis circuit 60 of the Practical Example EX1_B includes an amplitude deriver 61 and a determiner 65, and further includes a phase comparator 63. The amplitude deriver 61 has the same function as described in connection with the Practical Example EX1_A.

The phase comparator 63 is fed with the modulated component extraction signal S_{M} and the drive signal drv2. The phase comparator 63 compares the phase of the modulated component extraction signal S_{M} with the phase of the drive signal drv2 and derives the phase difference Δϕ between them. It is here assumed that the phase difference Δϕ represents the delay of the phase of the modulated component extraction signal S_{M} relative to the phase of the drive signal drv2.

As described earlier, the drive signal drv2 is the signal on which the drive signal DRV2 is based (see FIG. 1). The drive signal drv2 and the drive signal DRV2 have substantially the same phase, and it is here assumed that there is no difference between the phase of the drive signal drv2 and the phase of the drive signal DRV2. Then, the phase difference Δϕ represents the difference between the phase of the modulated component extraction signal S_{M} and the phase of the drive signal DRV2. Phase comparison between the signals S_{M} and drv2 is equivalent to phase comparison between the signals S_{M} and DRV2.

The determiner 65 in Practical Example EX1_B generates the diagnosis signal S_{DIAG} based on the amplitude A_{M} derived by the amplitude deriver 61 and the phase difference Δϕ derived by the phase comparator 63. The generated diagnosis signal S_{DIAG} is output from the diagnosis circuit 60.

The determiner 65 generates the diagnosis signal S_{DIAG} according to whether the phase difference Δϕ meets a predetermined suitable phase condition and whether the amplitude A_{M} of the modulated component extraction signal S_{M} falls outside a predetermined normal amplitude range. If the sensor element 10 is normal, the movable electrodes 12 and 13 vibrate mechanically at the modulation frequency f_{M} in synchronization with the drive signal DRV2, and thus a predetermined relationship is expected to hold between the phase of the modulated component extraction signal S_{M} and the phase of the drive signal DRV2 (hence the phase of the drive signal drv2). Based on this predetermined relationship, the above-mentioned suitable phase condition is defined. If the phase difference Δϕ falls within a predetermined suitable phase range, the suitable phase condition is met; if the phase difference Δϕ falls outside the predetermined suitable phase range, the suitable phase condition is not met.

Suppose that the acceleration sensor 1 is acted on by acceleration with a frequency within the pass band of the BPF 51. Then the signal component corresponding to that acceleration is contained in the modulated component extraction signal S_{M}. In that case, the sensor element 10 cannot be diagnosed properly based on the drive signal DRV2.

In view of that, the determiner 65 in Practical Example EX1_B operates as follows. If the phase difference Δϕ (the relationship between the two phases targeted for comparison) fulfills the predetermined suitable phase condition and in addition the amplitude A_{M} of the modulated component extraction signal S_{M} falls outside the predetermined normal amplitude range, the determiner 65 generates a diagnosis signal S_{DIAG} with the value of “1.” If the phase difference Δϕ fulfills the suitable phase condition and in addition the amplitude A_{M} of the modulated component extraction signal S_{M} falls within the predetermined normal amplitude range, the determiner 65 generates a diagnosis signal S_{DIAG} with the value of “0.”

If the phase difference Δϕ does not fulfill the predetermined suitable phase condition, regardless of the relationship between the amplitude A_{M} and the normal amplitude range, the determiner 65 gives the diagnosis signal S_{DIAG} the value of “0.” If the acceleration sensor 1 is acted on by acceleration with a frequency within the pass band of the BPF 51, the phase difference Δϕ is expected not to fulfill the suitable phase condition. In this way, by referring to the phase difference Δϕ, even if the acceleration sensor 1 is acted on by acceleration around the modulation frequency f_{M}, it is possible to avoid an incorrect diagnosis (a diagnosis that the sensor element 10 has a fault despite it being normal).

Information on the phase difference Δϕ may be fed also to the control circuit 70. The control circuit 70 can then, if the phase difference Δϕ (the relationship between the two phases targeted for comparison) does not fulfill the predetermined suitable phase condition, control the drive circuit 20 to change the modulation frequency f_{M}. This will now be elaborated. The drive circuit 20 is configured such that the modulation frequency f_{M} is switchable among a plurality of frequencies including frequencies f_{M1} and f_{M2} (f_{M1}≠f_{M2}). No matter which of those frequencies the modulation frequency f_{M} is set to, the modulation frequency f_{M} meets all the characteristics thus far described (hence, e.g., it fulfills f_{B}<f_{M}<f_{S}).

When the acceleration sensor 1 starts up, the modulation frequency f_{M} is set to the frequency f_{M1}. That is, the initial value of the modulation frequency f_{M} is f_{M1}. In the state f_{M}=f_{M1},” if the phase difference Δϕ fulfills the predetermined suitable phase condition, the control circuit 70 maintains the state f_{M}=f_{M1}. By contrast, in the state f_{M}=f_{M1},” if the phase difference Δϕ is detected not to fulfill the predetermined suitable phase condition, the control circuit 70 switches the modulation frequency f_{M} from the frequency f_{M1} to the frequency f_{M2} and after that drives the sensor element 10 in the state f_{M}=f_{M2}. In this way, even if the acceleration sensor 1 is acted on by acceleration around the frequency f_{M1}, the sensor element 10 can be diagnosed.

Under the control of the control circuit 70, in coordination with the switching of the modulation frequency f_{M}, also the pass band of the BPF 51 is switched. Specifically, the pass band of the BPF 51 is switched such that, in the state f_{M}=f_{M1}, the pass band of the BPF 51 includes the frequency f_{M1} and that, in the state f_{M}=f_{M2}, the pass band of the BPF 51 includes the frequency f_{M2}. Here, it is preferable that the width of the pass band of the BPF 51 be smaller than the absolute value |f_{M1}−f_{M2}| of the frequency difference. More specifically, it is preferable that, in the state f_{M}=f_{M1}, the pass band of the BPF 51 includes the frequency f_{M1} but not the frequency f_{M2} and that, in the state f_{M}=f_{M2}, the pass band of the BPF 51 includes the frequency f_{M2} but not the frequency f_{M1}. The aim is to prevent, in the state f_{M}=f_{M1}, acceleration with the frequency f_{M2} from affecting the diagnosis of the diagnosis circuit 60 and to prevent, in the state f_{M}=f_{MZ}, acceleration with the frequency f_{M1} from affecting the diagnosis of the diagnosis circuit 60.

### Second Embodiment

A second embodiment of the present disclosure will be described. While, in the first embodiment, attention is paid only to acceleration along a single axis, an acceleration sensor 1 can be a sensor capable of sensing acceleration along mutually different axes individually.

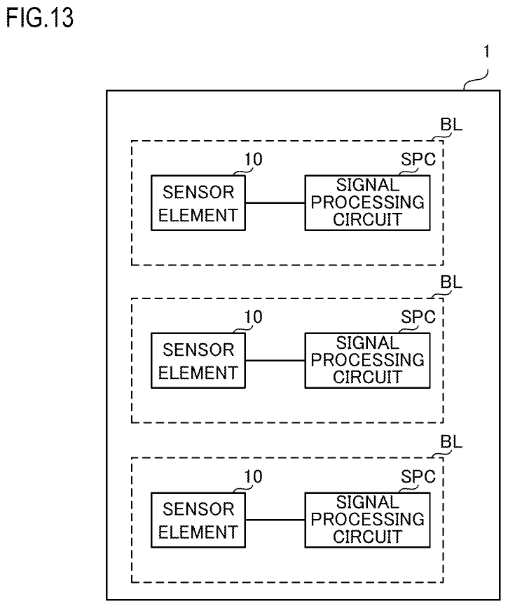

FIG. 13 is a configuration diagram of an acceleration sensor 1 configured as a three-axis acceleration sensor (hereinafter referred to as the three-axis acceleration sensor 1). The three-axis acceleration sensor 1 can sense acceleration individually along an X-axis, along a Y-axis, and along a Z-axis. Acceleration along the X-, Y-, and Z-axes refers to acceleration that acts on the three-axis acceleration sensor 1 along the X-, Y-, and Z-axes respectively. The X-, Y-, and Z-axes are three axes that are orthogonal to each other.

The three-axis acceleration sensor 1 includes three functional blocks BL each including a sensor element 10 and an signal processing circuit SPC. The three functional blocks BL are configured similarly, the differences being that, of the three functional blocks BL, the first functional block BL includes a sensor element 10 of which the a-axis (see FIG. 2) is the X-axis, the second functional block BL includes a sensor element 10 of which the a-axis (see FIG. 2) is the Y-axis, and the third functional block BL includes a sensor element 10 of which the a-axis (see FIG. 2) is the Z-axis.

In each functional block BL, the signal processing circuit SPC includes a drive circuit 20, a sense signal generation circuit 30, an acceleration signal generation circuit 40, a modulated component extraction circuit 50, a diagnosis circuit 60, and a control circuit 70 as described previously in connection with the first embodiment. In each functional block BL, the sensor element 10 and the circuits 20 to 70 operate as described in connection with the first embodiment. In this way, acceleration can be sensed individually along the X-, Y-, and Z-axes (that is, an acceleration signal S_{ACC} with respect to the X-axis, an acceleration signal S_{ACC} with respect to the Y-axis, and an acceleration signal S_{ACC} with respect to the z-axis can be generated), and diagnosis is possible with each of the sensor elements 10 individually. Instead of the signal processing circuit SPC in each functional block BL being provided with a control circuit 70, a single control circuit (unillustrated) shared among the three functional blocks BL may be provided in the three-axis acceleration sensor 1.

### Third Embodiment

A third embodiment of the present disclosure will be described. The third embodiment deals with modified technologies, applied technologies, and supplementary notes that are applicable to the first or second embodiment. Unless otherwise stated, the acceleration sensor 1 discussed in connection with the third embodiment is the acceleration sensor 1 described in connection with the first embodiment or the three-axis acceleration sensor 1 described in connection with the second embodiment.

The acceleration sensor 1 can be incorporated in any device. For example, the acceleration sensor 1 can be incorporated in a vehicle such as an automobile. In that case, the above-mentioned external device connected to the acceleration sensor 1 is, for example, a host system (such as an ECU [electronic control unit]) incorporated in the vehicle. Vehicle onboard components are often required to have a self-diagnose function. Self-diagnosis can be achieved, for example, as in a first and a second reference example described below.

In the first reference example, self-diagnosis is conducted by use of Coulomb forces. When self-diagnosis is conducted, ordinary operation for the sensing of acceleration is interrupted. In the first reference example, during self-diagnosis, ordinary sensing operation cannot be performed.

In the second reference example, a sensing element dedicated to self-diagnosis is additionally provided, and self-diagnosis is conducted by use of the sensing element dedicated to self-diagnosis. For example, in a case where the second reference example is applied to a three-axis acceleration sensor, a total of four sensing elements are required. The second reference example requires additional sensor elements and hence increased cost.

In contrast to these reference examples, with the acceleration sensor 1 according to the first or second embodiment, it is possible to diagnose the sensor element 10 while performing ordinary operation for the sensing of acceleration. It also requires no sensing elements for self-diagnosis as mentioned in connection with the second reference example. It is thus possible to diagnose the sensor element 10 without interrupting ordinary sensing operation and in addition at low cost. Through such diagnose it is possible to enhance the reliability of the system that includes the acceleration sensor 1.

While the embodiments described above deal with examples where the A/D conversion circuit 32 performs delta-sigma AD conversion, the A/D conversion circuit 32 may perform AD conversion by any other method.

Instead of the acceleration sensor 1 performing AD conversion, it can perform the necessary signal processing on an analog signal. Specifically, the A/D conversion circuit 32 may be omitted from the sense signal generation circuit 30 in FIG. 1, and the analog sense signal S_{A} can be fed to the acceleration signal generation circuit 40 and the modulated component extraction circuit 50. In that case, the LPF 41 and the BPF 51 are configured as analog circuits, and from the analog sense signal S_{A}, an analog acceleration signal S_{ACC} and an analog modulated component extraction signal S_{M} are generated.

The circuit elements constituting the acceleration sensor 1 are produced in the form of a semiconductor integrated circuit. This semiconductor integrated circuit is sealed in a case (package) made of resin to produce a semiconductor device. The sensor element 10 may be formed in one semiconductor chip and the other circuits (including the circuits 20-70) may be formed in another, separate, semiconductor chip, with these semiconductor chips sealed in a common case to produce a semiconductor device.

A modified configuration is possible where, of the components of the acceleration sensor 1 described above, the diagnosis circuit 60 is not included in the semiconductor device. In this modified configuration, an external device (host device; unillustrated) implemented with a microcomputer or the like is connected to the semiconductor device, and the diagnosis circuit 60 is provided in this external device. A modulated component extraction signal S_{M} output from the modulated component extraction circuit 50 in the semiconductor device can be fed to the external device so that the diagnosis circuit 60 in the external device generates a diagnosis signal S_{DIAG}.

For any signal or voltage, the relationship between its high and low levels may be reversed from what is described above so long as that can be done without departure from the intended technical concept.

The embodiments of the present invention can be modified in many ways as necessary without departure from the scope of the technical concepts defined in the appended claims. The embodiments described herein are merely examples of how the present invention can be implemented, and what is meant by any of the terms used to describe the present invention and its constituent elements is not limited to that mentioned in connection with the embodiments. The specific values mentioned in the above description are merely illustrative and needless to say can be modified to different values.

### NOTES

To follow are supplementary notes on the present disclosure of which specific configuration examples have been described above by way of embodiments.

According to one aspect of the present disclosure, an acceleration sensor (see FIG. 1) includes: a sensor element (10) having a first variable capacitor and a second variable capacitor whose respective capacitance values vary in mutually opposite directions according to acceleration; a drive circuit (20) configured to be capable of modulating a first drive signal (DRV1), which is to be fed to the sensor element to sense the acceleration, with a second drive signal (DRV2) having a predetermined modulation frequency (f_{M}) and feeding the sensor element with a signal containing components corresponding to the first and second drive signals respectively; a sense signal generation circuit (30) connected to the sensor element and configured to be capable of generating a sense signal (S_{A}, S_{D}) according to the difference between the capacitance values of the first and second variable capacitors; an acceleration signal generation circuit (40) configured to be capable of generating an acceleration signal (S_{ACC}) corresponding to the acceleration by subjecting the sense signal to low-pass filtering; and a modulated component extraction circuit (50) configured to be capable of generating a modulated component extraction signal (S_{M}) by extracting a signal component of the modulation frequency from the sense signal. (A first configuration.)

It is thus possible to diagnose the sensor element without interrupting operation for generating an acceleration signal (ordinary sensing operation) and without providing a separate sensor element dedicated to diagnosis (hence at low cost).

In the acceleration sensor of the first configuration described above, the modulation frequency (f_{M}) may be lower than the frequency (f_{S}) of the first drive signal but higher than a cut-off frequency (f_{CO}) of the low-pass filtering. (A second configuration.)

Owing to the modulation frequency being higher than the cut-off frequency, the acceleration signal is prevented from containing a component of the modulation frequency. That is, the effect of the modulation with the second drive signal on the generation of the acceleration signal (ordinary sensing operation) is suppressed. Moreover, to permit the capacitance values of the first and second variable capacitors to be varied with the second drive signal, the modulation frequency is set to be lower than the frequency of the first drive signal.

In the acceleration sensor of the first or second configuration described above, the capacitance values of the first and second variable capacitors may vary at the modulation frequency as a result of the component corresponding to the second drive signal being fed to the sensor element. (A third configuration.)

It is thus possible to diagnose whether the variable capacitors in the sensor element are in a variable state.

The acceleration sensor of any of the first to third configurations described above may further include a diagnosis circuit (60) configured to be capable of generating a diagnosis signal (S_{DIAG}) related to the state of the sensor element based on the modulated component extraction signal. (A fourth configuration.)

In the acceleration sensor of the fourth configuration described above, the diagnosis circuit may be configured to be capable of generating the diagnosis signal based on the amplitude of the modulated component extraction signal. (A fifth configuration.)

It is thus possible to generate a diagnosis signal that reflects whether the variable capacitors in the sensor element are in a variable state.

In the acceleration sensor of the fifth configuration described above, the diagnosis circuit may be configured to be capable of generating the diagnosis signal according to whether the amplitude of the modulated component extraction signal falls outside a predetermined range. (A sixth configuration.)

In the acceleration sensor of the sixth configuration described above, the diagnosis circuit may be configured to be capable of generating, as the diagnosis signal, a signal indicating that the sensor element has a fault if the amplitude of the modulated component extraction signal falls outside the predetermined range. (A seventh configuration.)

In the acceleration sensor of the fourth configuration described above, the diagnosis circuit is configured to be capable of generating the diagnosis signal according to the amplitude of the modulated component extraction signal, the phase of the modulated component extraction signal, and the phase of the second drive signal. (An eighth configuration.)

It is thus possible to generate a diagnosis signal that reflects whether the variable capacitors in the sensor element are in a variable state. Referring to the phases helps prevent an incorrect diagnosis even if the acceleration sensor is acted on by acceleration around the modulation frequency.

In the acceleration sensor of the eighth configuration described above, the diagnosis circuit may be configured to be capable of generating, as the diagnosis signal, a signal indicating that the sensor element has a fault if the relationship between the phase of the modulated component extraction signal and the phase of the second drive signal fulfills a predetermined condition and in addition the amplitude of the modulated component extraction signal falls outside the predetermined range. (A ninth configuration.)

The acceleration sensor of the ninth configuration described above may further include a control circuit configured to be capable of changing the modulation frequency if the relationship between the phase of the modulated component extraction signal and the phase of the second drive signal does not fulfill the predetermined condition. (A tenth configuration.)

It is thus possible, in a case where the modulation frequency is a particular frequency, to diagnose the sensor element with the modulation frequency changed from the particular frequency even if the acceleration sensor is acted on by acceleration with a frequency around the particular frequency.

1. An acceleration sensor, comprising:
a sensor element having a first variable capacitor and a second variable capacitor whose respective capacitance values vary in mutually opposite directions according to acceleration;
a drive circuit configured to be capable of
modulating a first drive signal, which is to be fed to the sensor element to sense the acceleration, with a second drive signal having a predetermined modulation frequency and
feeding the sensor element with a signal containing components corresponding to the first and second drive signals respectively;
a sense signal generation circuit connected to the sensor element and configured to be capable of generating a sense signal according to a difference between the capacitance values of the first and second variable capacitors;
an acceleration signal generation circuit configured to be capable of generating an acceleration signal corresponding to the acceleration by subjecting the sense signal to low-pass filtering; and
a modulated component extraction circuit configured to be capable of generating a modulated component extraction signal by extracting a signal component of the modulation frequency from the sense signal.

2. The acceleration sensor according to claim 1, wherein
the modulation frequency is lower than a frequency of the first drive signal but higher than a cut-off frequency of the low-pass filtering.

3. The acceleration sensor according to claim 1, wherein
the capacitance values of the first and second variable capacitors vary at the modulation frequency as a result of the component corresponding to the second drive signal being fed to the sensor element.

4. The acceleration sensor according to claim 1, further comprising a diagnosis circuit configured to be capable of generating a diagnosis signal related to a state of the sensor element based on the modulated component extraction signal.

5. The acceleration sensor according to claim 4, wherein
the diagnosis circuit is configured to be capable of generating the diagnosis signal based on an amplitude of the modulated component extraction signal.

6. The acceleration sensor according to claim 5, wherein
the diagnosis circuit is configured to be capable of generating the diagnosis signal according to whether the amplitude of the modulated component extraction signal falls outside a predetermined range.

7. The acceleration sensor according to claim 6, wherein
the diagnosis circuit is configured to be capable of generating, as the diagnosis signal, a signal indicating that the sensor element has a fault if the amplitude of the modulated component extraction signal falls outside the predetermined range.

8. The acceleration sensor according to claim 4, wherein
the diagnosis circuit is configured to be capable of generating the diagnosis signal according to an amplitude of the modulated component extraction signal, a phase of the modulated component extraction signal, and a phase of the second drive signal.

9. The acceleration sensor according to claim 8, wherein
the diagnosis circuit is configured to be capable of generating, as the diagnosis signal, a signal indicating that the sensor element has a fault if
a relationship between the phase of the modulated component extraction signal and the phase of the second drive signal fulfills a predetermined condition and in addition
the amplitude of the modulated component extraction signal falls outside the predetermined range.

10. The acceleration sensor according to claim 9, further comprising a control circuit configured to be capable of changing the modulation frequency if the relationship between the phase of the modulated component extraction signal and the phase of the second drive signal does not fulfill the predetermined condition.
